(19) United States
(12) Patent Application Publication
(10) Pub. No.: US 2026/0001635 A1
(43) Pub. Date: Jan. 1, 2026

(54) PERSONAL SAFETY DEVICE AND ASSOCIATED ACCESSORIES

(71) Applicants: Danna Kimpel, Hicksville, OH (US); Justin Meyer, Woodstock, GA (US)

(72) Inventors: Danna Kimpel, Hicksville, OH (US); Justin Meyer, Woodstock, GA (US)

(21) Appl. No.: 19/252,640

(22) Filed: Jun. 27, 2025

Related U.S. Application Data
(60) Provisional application No. 63/664,949, filed on Jun. 27, 2024.

(51) Int. Cl. B63C 9/00; G06K 19/06; G06K 19/07

(52) U.S. Cl. CPC B63C 9/0005; G06K 19/06037; G06K 19/0723

(57) ABSTRACT

A personal safety device is disclosed. The personal safety device comprises an inner core and an outer layer disposed on the inner core. The personal safety device is selectively transformable between a rigid first state and a flexible second state. The inner core and/or the outer layer may be produced from a material or combination of materials, which results in the personal safety device having a desired buoyancy rating. A void/cavity may be formed in the inner core, the outer layer, and/or between the inner core and the outer layer, to contain air or another gaseous material, which results in the personal safety device having the desired buoyancy rating. An accessory device may be coupled to the personal safety device for added benefits and features.

### CROSS-REFERENCE TO RELATED APPLICATION

This application claims the benefit of U.S. Provisional Patent Application Ser. No. 63/664,949, filed Jun. 27, 2024, the entirety of which is herein incorporated by reference.

### FIELD

The present disclosure relates generally to a safety device, and more particularly to a compact personal safety device and associated accessories for use during activities.

### BACKGROUND

Outdoor activities, particularly water activities, can be exhilarating but also pose risks, making personal water safety solutions essential. Traditional devices like life jackets and personal floatation devices (PFDs) are designed to keep individuals afloat in water. When engaging in water sports or activities like boating, kayaking, or swimming, wearing a water safety device is vital because they can prevent drowning by providing buoyancy. While conventional devices are crucial for preventing drowning, they often fall short in two key areas: visibility and communication. In dynamic environments such as boating, kayaking, or swimming, being seen and staying connected can be just as important as staying afloat. Poor weather, rough waters, or low-light conditions can make it difficult for rescuers or fellow participants to locate someone in distress. Additionally, conventional PFDs lack built-in communication features, which can delay response times in emergencies. Inflatable PFDs require complex activation or compressed gas cartridges for inflation, which may not be intuitive in emergency situations, especially for young or inexperienced users. Regular inspection and maintenance are required to ensure that inflatable PFDs and other devices remain functional and reliable. Additionally, high-quality, reliable PFDs can be expensive, which might deter people from purchasing or replacing them as needed. Moreover, not all PFDs are suitable for every water activity, which could lead to confusion or improper use.

Accordingly, there exists a need for a personal safety device and associated accessories that provide and improve safety, usability, visibility, and communication during activities.

### SUMMARY

In concordance and agreement with the instant disclosure, a personal safety device that provides and improves safety, usability, and visibility during activities, has surprisingly been invented.

The exemplary embodiment(s) described hereinbelow and shown in the drawings disclose a personal safety device that is convenient and easy to use, lightweight yet durable in design, and versatile in application.

In one embodiments, a personal safety device, comprises: an inner core; and an outer layer disposed on the inner core, wherein the personal safety device is selectively transformable between a rigid first state and a flexible second state, and wherein the personal safety device has a desired buoyancy rating.

In another embodiment, a system, comprises: a personal safety device selectively transformable between a rigid first state and a flexible second state; and an accessory device coupled to the personal safety device, wherein the system has a desired buoyancy rating.

In yet another embodiments, a method, comprises: providing a personal safety device; selectively transforming the personal safety device from a flexible state to a rigid state; and signaling distress and/or a need for assistance to a third-party and/or emergency response personnel using the personal safety device.

As aspects of some embodiments, the desired buoyancy rating is at least a weight of the personal safety device.

As aspects of some embodiments, the desired buoyancy rating is in a range of about 150 grams to about 250 grams of buoyancy.

As aspects of some embodiments, one or more of the inner core and/or the outer layer includes a void/cavity for containing air or another gaseous material that results in the personal safety device having the desired buoyancy rating.

As aspects of some embodiments, a void/cavity is formed between the inner core and the outer layer for containing air or another gaseous material that results in the personal safety device having the desired buoyancy rating.

As aspects of some embodiments, the outer layer is formed from one or more of a bright colored material and/or a patterned material and/or a reflective material.

As aspects of some embodiments, at least one surface of the personal safety device includes one or more designated areas for identifying information, marketing information, and/or source information.

As aspects of some embodiments, the inner core is produced from one or more materials that results in the inner core performing as a spring body.

As aspects of some embodiments, the outer layer is produced from one or more of a flexible material and/or a corrosion-resistant material and/or a waterproof material and/or a water-resistant material.

As aspects of some embodiments, the personal safety device includes one or more of an identifier and/or an embedded radio frequency identification (RFID) tag and/or a quick response (QR) code associated with a database that has stored emergency contact information or health data of a user.

As aspects of some embodiments, the personal safety device includes one or more of an indicator and/or a transmitter and/or a receiver and/or a near-filed communication (NFC) chip and/or an audio input and/or an audio output and/or a battery and/or a controller and/or a computing device.

As aspects of some embodiments, the desired buoyancy rating of the system is at least a combined weight of the personal safety device and the accessory device.

As aspects of some embodiments, the accessory device includes a void/cavity for containing air or another gaseous material that results in the system having the desired buoyancy rating.

As aspects of some embodiments, the void/cavity is formed between an inner core and a housing of the accessory device.

As aspects of some embodiments, at least one surface of the accessory device includes one or more designated areas for identifying information, marketing information, and/or source information.

As aspects of some embodiments, a housing of the accessory device is produced from one or more of a corrosion-resistant material and/or a waterproof material and/or a water-resistant material.

As aspects of some embodiments, the accessory device includes one or more of an identifier and/or an embedded radio frequency identification (RFID) tag and/or a quick response (QR) code associated with a database that has stored emergency contact information or health data of a user.

As aspects of some embodiments, the accessory device includes one or more of an indicator and/or a transmitter and/or a receiver and/or a near-filed communication (NFC) chip and/or an audio input and/or an audio output and/or a battery and/or a controller and/or a computing device.

### BRIEF DESCRIPTION OF THE DRAWINGS

The above-mentioned, and other features and objects of the present disclosure, and the manner of attaining them, will become more apparent and the present disclosure itself will be better understood by reference to the following descriptions of embodiments of the present disclosure taken in conjunction with the accompanying drawings, wherein:

FIG. 1 is a perspective view of a personal safety device according to an embodiment of the present disclosure, showing the personal safety device in an elongated first state and disposed in a protective sleeve;

FIG. 2 is a top plan view of the personal safety device of FIG. 1 in the first state thereof;

FIG. 3 is a fragmentary perspective view partially in section of the personal safety device of FIGS. 1 and 2 in the first state thereof;

FIG. 4 is a perspective view of the personal safety device of FIGS. 1-3 in a coiled second state thereof

FIG. 5 is a front view of a personal safety device according to an embodiment of the present disclosure in use with a personal flotation device;

FIG. 6 is a front view of a personal safety device according to an embodiment of the present disclosure in an alternative use with a personal flotation device;

FIG. 7 is a top plan view of an accessory device according to an embodiment of the present disclosure;

FIG. 8 is a cross-sectional view taken long section line A-A in FIG. 7 of the accessory device;

FIG. 9 is a fragmentary view of the personal safety device of FIGS. 1-4 coupled to the accessory device of FIGS. 7 and 8;

FIG. 10 is a schematic representation of a user wearing the personal safety device of FIGS. 1-4, wherein the personal safety device is in the second state; and

FIG. 11 is a schematic representation of a user employing the use of the personal safety device of FIGS. 1-4, wherein the personal safety device is in the first state.

### DETAILED DESCRIPTION

The following description of technology is merely exemplary in nature of the subject matter, manufacture and use of one or more embodiments of the present disclosure, and is not intended to limit the scope, application, or uses of any specific embodiments claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

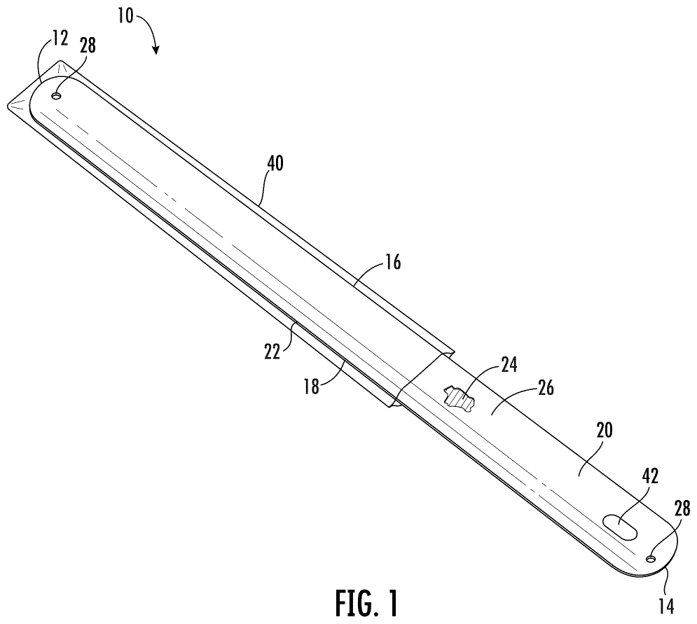

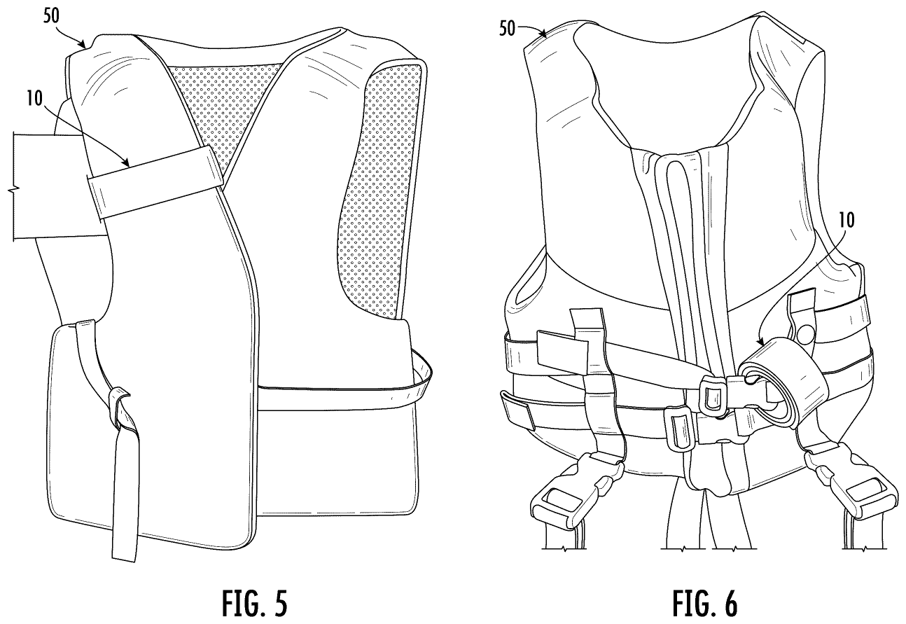

FIGS. 1-4 illustrate exemplary embodiments of a personal safety device 10 for use in activities, preferably water activities, in accordance with the present disclosure. It should be appreciated, however, that the personal safety device 10 may also be configured and adapted to many different types of applications as well as for use with various other objects. For example, the personal safety device 10 may be configured to be directly attached to the user or used with a personal floatation device (PFD) 50, as shown in FIGS. 5 and 6. It is understood that the personal safety device 10 may be sized to fit around an overlap a wrist, forearm or other body part of the user. In another non-limiting example, the personal safety device 10 may be configured to attach to equipment used in various physical activities (e.g., a helmet, a ski, a paddle, etc.). Various means and methods may be employed for such attachment, for example, fastener(s) (e.g., mechanical fasteners, hook-and-loop devices), magnet(s), adhesive(s) (e.g., tape), and the like. In yet another non-limiting example, the personal safety device 10 may be used as a locator and/or distress indicator when the user is in large crowds and/or venues.

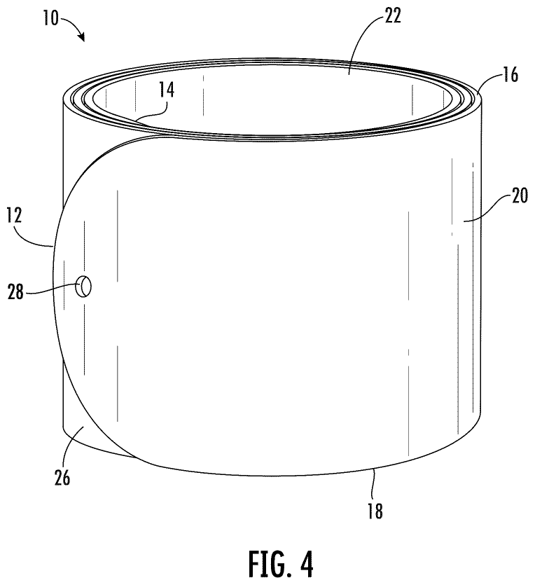

The personal safety device 10 may be configured to be selectively transformable between various physical states or possible positions. In certain embodiments, the personal safety device 10 may be bistable and transformable between a substantially rigid first state, as depicted in FIGS. 1-3, and a substantially flexible second state, as depicted in FIGS. 4-6. In the first state, the personal safety device 10 is generally elongated, and in the second state, the personal safety device 10 is generally coiled. The configuration of the personal safety device 10 in the second state may vary depending on an object for which the personal safety device 10 is coiled around, an initial strength of the personal safety device 10, and a number of times the personal safety device 10 has been transformed between the first and second states. In most instances, a diameter of the personal safety device 10 in the second state (as shown in FIGS. 5 and 6) varies and conforms to a diameter and shape of the object it is coiled around.

The personal safety device 10 includes a first end 12, a second end 14, and opposing sides 16, 18 extending between the ends 12, 14. One or more of the ends 12, 14 and/or corners of the personal safety device 10 may be coped, chamfered, or rounded. As best illustrated in FIG. 3, at least a portion of the personal safety device 10 may have a generally arcuate cross-sectional shape when the personal safety device 10 is in the first state. Particularly, a first surface 20 of the personal safety device 10 has a generally concave shape and a second surface 22 thereof has a generally convex shape. In some embodiments, the arcuate-shaped portion of the personal safety device 10 may have a radius of curvature of in a range of about 30 mm to about 40 mm, and more particularly about 35 mm. As a non-limiting example, the personal safety device 10 may have a thickness in a range of about 1 mm to about 10 mm, and more particularly about 2 mm; a width in a range of about 5 mm to about 100 mm, and more particularly about 50 mm; and a length (as best seen in the second state) in a range of about 100 mm to about 1000 mm, and more particularly about 500 mm. It is understood, however, that the personal safety device 10 may have any suitable size, shape, and dimensions as desired.

As illustrated in FIGS. 1 and 3, the personal safety device 10 may comprise an inner core 24 and an outer layer 26 disposed on the inner core 24. One or more openings 28 may be formed in the personal safety device 10 extending through the inner core 24 and the outer layer 26. The openings 28 may be configured for attachment of an accessory device 100 described hereinbelow. In some embodiments, the openings 28 may be formed in at least one of the ends 12, 14 of the personal safety device 10. It should be appreciated, however, that in other embodiments, the openings 28 may be formed elsewhere in the personal safety device 10 as desired.

The personal safety device 10, and more particularly, the inner core 24 may have any suitable size, shape, and configuration as desired depending on the intended application of the personal safety device 10. The inner core 24 may perform as a spring body. For example, when the personal safety device 10 is in the first state (as shown in FIGS. 1-3) and an intermediate portion and/or an area of the arcuate portion thereof is struck against a mounting object or structure (e.g., a wrist, ankle, or forearm of the user, a portion of the PFD as illustrated in FIGS. 5 and 6, etc.) the personal safety device 10 transforms from the first state to the second state (as shown in FIGS. 4-6).

It should be appreciated that the inner core 24 may be produced from any suitable material or combination of materials that results in the inner core 24 performing as the spring body. For example, the material may be a metal, a non-metal (e.g., a plastic), or a combination thereof.

It should also be appreciated that the inner core 24 may be produced from any material or combination of materials that results in the personal safety device 10 being buoyant or having a desired buoyancy rating. In some instances, the desired buoyancy rating of the personal safety device 10 may be at least a weight of the personal safety device 10. In other embodiments, the desired buoyancy rating of the personal safety device 10 may be in a range of about 150 grams to about 250 grams of buoyancy. In a preferred embodiment, the desired buoyancy rating of the personal safety device 10 may be at least twice the weight of the personal safety device 10.

As depicted in FIGS. 1-3, the outer layer 26 may encapsulate at least a portion of the inner core 24. In some embodiments, the outer layer 26 may be disposed directly on the inner core 24 of the personal safety device 10. A thickness of the outer layer 26 may be in a range of about 0.1 mm to about 1.5 mm, and more preferably about 0.8 mm. It should be appreciated that any suitable method may be employed to cover the inner core 24 with the outer layer 26 such as by a coating process, a deposition process, and the like, for example. In certain embodiments, the outer layer 26 may be produced from a flexible material (e.g., a silicone), a corrosion-resistant material, or combination of flexible and corrosion-resistant materials that results in the personal safety device 10 being durable and easy to use. Additionally, the material or combination of materials used for the outer layer 26 may exhibit other critical physical characteristics such as being waterproof or water-resistant to improve usability and versatility of the personal safety device 10. The outer layer 26 may also be produced from a material or combination of materials that results in the personal safety device 10 having the desired buoyancy rating as described hereinabove. It is understood, however, that the personal safety device 10, particularly the inner core 24 and the outer layer 26, may be configured to result in the personal safety device 10 having any desired buoyancy rating. In other embodiments, the personal safety device 10 may include a void/cavity (not depicted) for containing air or another gaseous material that results in the personal safety device 10 having the desired buoyancy rating. The void/cavity may be formed directly in the inner core 24 and/or the outer layer 26, or as a space between the inner core 24 and the outer layer 26.

Additionally, the material or combination of materials used for the outer layer 26 may exhibit other critical physical characteristics such as being waterproof or water-resistant to improve usability of the personal safety device 10, and/or being a bright color, patterned, and/or reflective to enhance visibility of the personal safety device 10 and/or the user, for example.

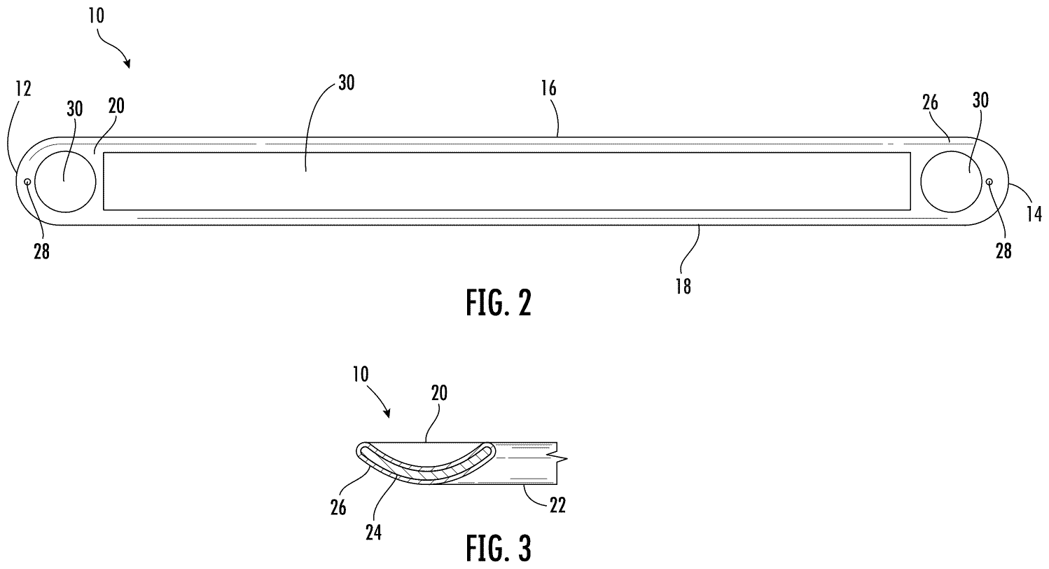

As illustrated in FIG. 2, the personal safety device 10 may also include one or more designated areas 30 for identifying information of the user, and/or marketing information, and/or source information of the personal safety device 10, for example, name, address, contact details (e.g., telephone number, email, social media), photograph, logo, slogan, etc. Although the designated areas 30 shown are located on the first surface 20 of the personal safety device 10, it is understood that the designated areas 30 can be located elsewhere on the personal safety device 10 and in any suitable position as desired. In some instances, the designated areas 30 may be located on both the first and second surfaces 20, 22 of the personal safety device 10.

In some embodiments, the identifying/marketing information and/or source information may be provided on the personal safety device 10, and preferably the outer layer 26, by any suitable method as desired such as a forming process of the outer layer 26 (e.g., extruding, injection molding, etc.), a subtractive manufacturing process removing material from the outer layer 26 (e.g., embossing, engraving, cutting, etc.), and/or an additive manufacturing process supplementing the outer layer 26 (e.g., three-dimensional printing, mechanical and/or chemical fastening, etc.). It is understood that in embodiments of the personal safety device 10 that are without the outer layer 26, the identifying/marketing information and/or source information may be provided on the inner core 24 of the personal safety device 10.

A protective sleeve 40 (shown in dashed lines in FIG. 1) may be employed to store the personal safety device 10 when not in use. Although the sleeve 40 shown covers only a portion of the personal safety device 10, it is understood that the sleeve 40 may be any shape, size, and configuration as desired to cover any portion, or all, of the personal safety device 10. The sleeve 40 may be produced from any suitable material (e.g., polyester) or combination of materials that provides a desired level of protection to the personal safety device 10. The sleeve 40 may also contain identifying/marketing information of the user and/or the source of the personal safety device 10 as described hereinabove. Additionally, the sleeve 40 may include other features (e.g., an eyelet, a carabiner, etc.) for attachment to the user or other object such as a keychain, PFD, and the like, for example.

It should be contemplated that the personal safety device 10 may include other various features 42 (schematically depicted in FIG. 1) to improve and enhance the safety, usability, and visibility during activities. In some embodiments, the features 42 of the personal safety device 10 may include, but are not limited to, a unique identifier (e.g., a number), and/or an embedded radio frequency identification (RFID) tag, and/or a quick response (QR) code associated with a database that has stored emergency contact information or other related health data of the user. Additionally or alternatively, the features 42 of the personal safety device 10 may include, but are not limited to, one or more of an indicator (e.g., light and/or beacon), transmitter and/or receiver (e.g. a radio frequency transmitter and/or receiver), a near-filed communication (NFC) chip, audio input and/or output, a battery, and/or a controller or other computing device.

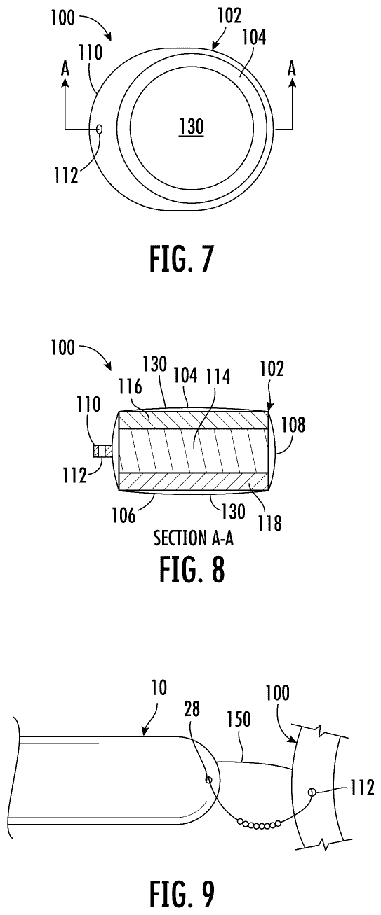

FIGS. 7-9 illustrate an accessory device 100 for use with the personal safety device 10. It should be appreciated that the accessory device 100 may also be configured and adapted to many different types of applications as well as for use with various other objects.

As illustrated, the accessory device 100 may be generally puck-shaped and have a desired buoyancy rating. It is understood, however, that the accessory device 100 may have any size, shape, and configuration as desired. In some instances, the desired buoyancy rating of the accessory device 100 may be at least a combined weight of the accessory device 100 and the personal safety device 10. In other embodiments, the desired buoyancy rating of the accessory device 100 may be in a range of about 150 grams to about 250 grams of buoyancy. In a preferred embodiment, the desired buoyancy rating of the accessory device 100 may be at least a buoyancy rating to provide floatation of the accessory device 100 along with the personal safety device 10.

In some embodiments, a desired buoyancy rating of a system comprising the personal safety device and the accessory device 100 may be at least the combined weight of the personal safety device 10 and the accessory device 100. In other embodiments, the desired buoyancy rating of the system comprising the personal safety device 10 and the accessory device 100 may be in a range of about 150 grams to about 250 grams of buoyancy. In a preferred embodiment, the desired buoyancy rating of the system comprising the personal safety device 10 and the accessory device 100 may be at least a buoyancy rating to provide floatation of the system.

In the embodiment shown, the accessory device 100 includes a hollow housing 102. The hollow housing 102 may be substantially fluid-tight to militate against leakage of an external material into an interior thereof and/or leakage of an internal material from the interior of the housing 102. The housing 102 shown includes a first surface 104, an opposite second surface 106, and an outer circumferential surface 108 extending between the first and second surfaces 104, 106. Each of the surfaces 104, 106, 108 may be substantially planar or generally arcuate as depicted in FIG. 8. In certain embodiments, the housing 102 may further include an outwardly extending projection 110. One or more openings 112 may be formed in the accessory device 100 for attachment to the personal safety device 10. In some embodiments, the openings 112 may be formed in the projection 110. It should be appreciated, however, that in other embodiments, the openings 112 may be formed elsewhere in the accessory device 100 as desired.

It should be appreciated that the housing 102 may be produced from a corrosion-resistant material or a combination of corrosion-resistant materials that results in the accessory device 100 being durable and easy to use. Additionally, the material or combination of materials used for the housing 102 may exhibit other critical physical characteristics such as being waterproof or water-resistant to improve usability and versatility of the accessory device 100. The housing 102 may also be produced from a material or combination of materials that results in the accessory device 100 having the desired buoyancy rating described hereinabove. In some embodiments, the housing 102 may include an outer layer (not depicted) disposed thereon. It should be appreciated that any suitable method may be employed to cover the housing 102 with the outer layer such as by a coating process, a deposition process, and the like, for example. In certain embodiments, the outer layer may be produced from a corrosion-resistant material or a combination of corrosion-resistant materials that results in the accessory device 100 being durable and easy to use. Additionally, the material or combination of materials used for the outer layer may exhibit other critical physical characteristics such as being waterproof or water-resistant to improve usability and versatility of the accessory device 100. The outer layer may also be produced from a material or combination of materials that results in the accessory device 100 having the desired buoyancy rating as described hereinabove

Air or another gaseous material and/or an inner core 114 may be disposed in the interior of the housing 102 that results in the accessory device 100 having the desired buoyancy rating. It should also be appreciated that the inner core 114 may be produced from any material or combination of materials that results in the accessory device 100 being buoyant or having the desired buoyancy rating, for example, a foam material. Additionally or alternatively, a void/cavity may be formed directly in the inner core 114 or as a space between the inner core 114 and the housing 102 to contain the air or gaseous material to achieve the desired buoyancy rating.

In some embodiments, the accessory device 100 may also include one or more features 116, 118 disposed in the interior of the housing 102 to improve and enhance the safety, usability, and visibility during activities. In some embodiments, the features 116, 118 of the accessory device 100 may include, but are not limited to, a unique identifier (e.g., a number), and/or an embedded radio frequency identification (RFID) tag, and/or a quick response (QR) code associated with a database that has stored emergency contact information or other related health data of the user. Additionally or alternatively, the features 116, 118 of the accessory device 100 may include, but are not limited to, one or more of an indicator (e.g., light and/or beacon), transmitter and/or receiver (e.g. a radio frequency transmitter and/or receiver), a near-filed communication (NFC) chip, audio input and/or output, a battery, and/or a controller or other computing device.

As best seen in FIG. 7, the accessory device 100 may also include one or more designated areas 130 for identifying information of the user, and/or marketing information, and/or source information of the accessory device 100, for example, name, address, contact details (e.g., telephone number, email, social media), photograph, logo, slogan, etc. Although the designated areas 130 shown are located on the first surface 104 of the housing 102, it is understood that the designated areas 130 can be located elsewhere on the accessory device 100 and in any suitable position as desired. In some instances, the designated areas 130 may be located on both the first and second surfaces 104, 106 of the housing 102, as depicted in FIG. 8.

In some embodiments, the identifying/marketing information and/or source information may be provided on the accessory device 100, and preferably the housing 102, by any suitable method as desired such as a forming process (e.g., extruding, injection molding, etc.), a subtractive manufacturing process (e.g., embossing, engraving, cutting, etc.), and/or an additive manufacturing process (e.g., three-dimensional printing, mechanical and/or chemical fastening, etc.). It is understood that in embodiments of the accessory device 100 that include the outer layer disposed on the housing 102, the identifying/marketing information and/or source information may be provided on the outer layer covering the housing 102 if desired.

A connector 150 (shown in FIG. 9) may be employed to couple the accessory device 100 to the personal safety device 10. Although the connector 150 depicted is a ball chain, it is understood that any means and methods of coupling (e.g., fixedly, releasably, directly, indirectly, etc.) the devices 10, 100 to each other may be employed as desired.

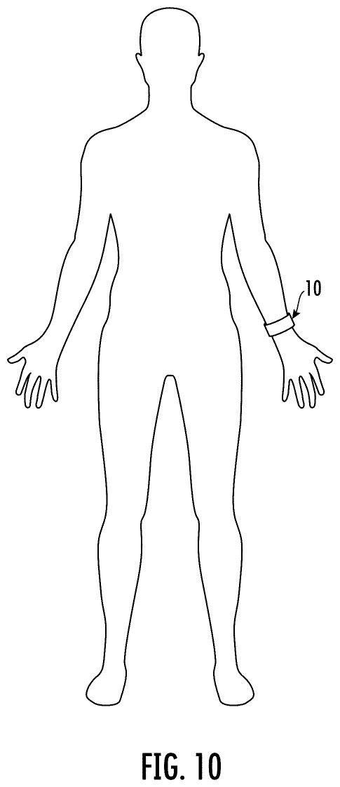

Prior to participating in the desired activity, the user starts with the personal safety device 10 in the first state (as shown in FIGS. 1-3). The user then grasps the personal safety device 10 and strikes it against an object (e.g., the wrist, ankle, or forearm of the user, the portion of the PFD, etc.) for attachment thereto. At this point, the inner core 24 transforms from the first state to the second state (as shown in FIGS. 4-6). As such, the personal safety device 10 is coiled around the object and attached thereto. For example, the personal safety device 10 can be coiled around an arm of the user, as shown in FIG. 10. The user is then prepared to engage in the desired activity.

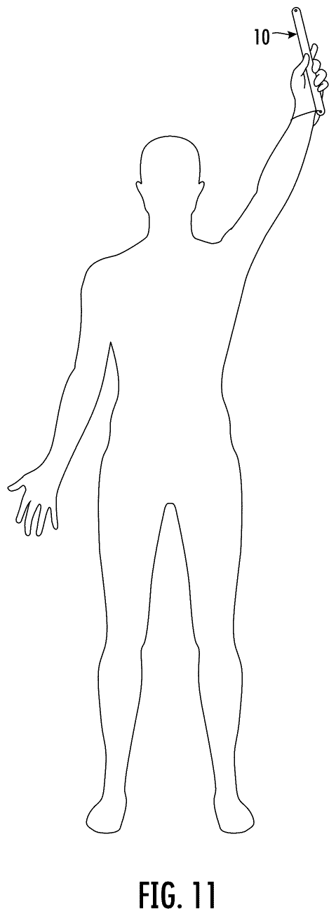

When use of the personal safety device 10 is necessitated and/or desired, the user grasps the personal safety device 10 in its coiled configuration, removes it from the object for which it is attached, and returns it to the elongated first state. To do so, the user manually pulls apart and separates both ends 12, 14 of the personal safety device 10, and snaps the personal safety device 10 back to the first state until the inner core 24 is elongated and rigid. In some circumstances, the user may then use the personal safety device 10 to signal and/or alert a third-party and/or emergency response personnel and/or others that the user may be in distress and/or in need for assistance. For example, the user may wave the personal safety device 10, as shown in FIG. 11, and/or employ at least one of the various other features of the personal safety device 10 such as the indicator (e.g., light and/or beacon), transmitter and/or receiver (e.g. a radio frequency transmitter and/or receiver), near-field communication (NFC) chip, audio input and/or output, battery, and/or controller or other computing device for, among other benefits, safety, visibility, and communication.

From the foregoing description, one ordinarily skilled in the art can easily ascertain the essential characteristics of this present disclosure and, without departing from the spirit and scope thereof, can make various changes and modifications to the present disclosure to adapt it to various usages and conditions.

What is claimed is:

1. A personal safety device, comprising:
an inner core; and
an outer layer disposed on the inner core, wherein the personal safety device is selectively transformable between a rigid first state and a flexible second state, and wherein the personal safety device has a desired buoyancy rating.

2. The personal safety device of claim 1, wherein the desired buoyancy rating is at least a weight of the personal safety device.

3. The personal safety device of claim 1, wherein the desired buoyancy rating is in a range of about 150 grams to about 250 grams of buoyancy.

4. The personal safety device of claim 1, wherein one or more of the inner core and/or the outer layer includes a void/cavity for containing air or another gaseous material that results in the personal safety device having the desired buoyancy rating.

5. The personal safety device of claim 1, wherein a void/cavity is formed between the inner core and the outer layer for containing air or another gaseous material that results in the personal safety device having the desired buoyancy rating.

6. The personal safety device of claim 1, wherein the outer layer is formed from one or more of a bright colored material and/or a patterned material and/or a reflective material.

7. The personal safety device of claim 1, wherein at least one surface of the personal safety device includes one or more designated areas for identifying information, marketing information, and/or source information.

8. The personal safety device of claim 1, wherein the inner core is produced from one or more materials that results in the inner core performing as a spring body.

9. The personal safety device of claim 1, wherein the outer layer is produced from one or more of a flexible material and/or a corrosion-resistant material and/or a waterproof material and/or a water-resistant material.

10. The personal safety device of claim 1, wherein the personal safety device includes one or more of an identifier and/or an embedded radio frequency identification (RFID) tag and/or a quick response (QR) code associated with a database that has stored emergency contact information or health data of a user.

11. The personal safety device of claim 1, wherein the personal safety device includes one or more of an indicator and/or a transmitter and/or a receiver and/or a near-filed communication (NFC) chip and/or an audio input and/or an audio output and/or a battery and/or a controller and/or a computing device.

12. A system, comprising:
a personal safety device selectively transformable between a rigid first state and a flexible second state; and
an accessory device coupled to the personal safety device, wherein the system has a desired buoyancy rating.

13. The system of claim 12, wherein the desired buoyancy rating of the system is at least a combined weight of the personal safety device and the accessory device.

14. The system of claim 12, wherein the accessory device includes a void/cavity for containing air or another gaseous material that results in the system having the desired buoyancy rating.

15. The system of claim 14, wherein the void/cavity is formed between an inner core and a housing of the accessory device.

16. The system of claim 12, wherein at least one surface of the accessory device includes one or more designated areas for identifying information, marketing information, and/or source information.

17. The system of claim 12, wherein a housing of the accessory device is produced from one or more of a corrosion-resistant material and/or a waterproof material and/or a water-resistant material.

18. The system of claim 12, wherein the accessory device includes one or more of an identifier and/or an embedded radio frequency identification (RFID) tag and/or a quick response (QR) code associated with a database that has stored emergency contact information or health data of a user.

19. The system of claim 12, wherein the accessory device includes one or more of an indicator and/or a transmitter and/or a receiver and/or a near-filed communication (NFC) chip and/or an audio input and/or an audio output and/or a battery and/or a controller and/or a computing device.

20. A method, comprising:
providing a personal safety device;
selectively transforming the personal safety device from a flexible state to a rigid state; and
signaling distress and/or a need for assistance to a third-party and/or emergency response personnel using the personal safety device.
